(19) United States
(12) Patent Application Publication
(10) Pub. No.: US 2010/0147973 A1
(43) Pub. Date: Jun. 17, 2010

(54) IMPINGEMENT SPRINKLER WITH VARIABLE OUTFLOW

(76) Inventor: Cheng-An WANG, Chang Hua Hsien (TW)

Correspondence Address: EGBERT LAW OFFICES, 412 MAIN STREET, 7TH FLOOR, HOUSTON, TX, 77002, US

(21) Appl. No.: 12/335,497

(22) Filed: Dec. 15, 2008

(51) Int. Cl. B05B 3/08

(52) U.S. Cl. 239/231

(57) ABSTRACT

The present invention provides an impingement sprinkler with variable outflow, including a main body, containing a moving inlet connector bolted at the bottom, a spray nozzle, an impingement deflector ledge, flexibly assembled onto the preset location of the main body, and an adjustable spray nozzle. The deflector ledge has a hydraulic pushing portion and a torsional spring arranged laterally thereon. The hydraulic pushing portion is positioned correspondingly at intervals in front of the spray nozzle. The adjustable spray nozzle is rotated manually to adjust the water outflow mode and arranged at intervals with the spray nozzle of the main body. The adjustable spray holes are arranged circularly at intervals and each have a different outflow.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an impingement sprinkler, and more particularly to an innovative sprinkler with variable outflow.

2. Description of Related Art Including Information Disclosed Under 37 CFR 1.97 and 37 CFR 1.98

The extensive water spraying in gardening work is often achieved by an impingement sprinkler, since it allows for circulating or reciprocating water spraying in a circumferential range.

As shown in FIG. 1, the typical impingement sprinkler still has some problems in actual applications, e.g. the uniformity of water spraying. After the spray nozzle 02 of typical impingement sprinkler 01 is set, parabolic water spraying will be generated from a fixed inclination, so the falling water is concentrated into a certain range, leading to lack of water or even absence of water spraying outside of this range to the assembly position of the impingement sprinkler 01. Thus, owing to non-uniform dispersal of water falling in the circumferential range, the impingement sprinkler 01 cannot fully cover the spraying area, resulting in irregular irrigation and poor plant growing effects.

Referring to FIG. 2, there is a schematic view of the irrigation range of a typical impingement sprinkler 01, wherein the spray nozzle 02 of the impingement sprinkler 01 is often formed with a fixed inclination. In the case of water spraying, the falling water will usually be concentrated into a spacing distance (shown in FIG. A), leading to lack of water (shown in FIG. B) or even absence of water spraying (shown in FIG. C) from this distance to the assembly position of the spray nozzle 02.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

Based on the unique present invention, an impingement sprinkler with variable outflow is provided with an adjustable spray nozzle, so that the impingement sprinkler enables water spraying in two modes. The adjustable spray nozzle permits longer or shorter distances of water spraying in relation to the spray nozzle of the main body, making it possible to resolve the disadvantage of the spray nozzle of the main body by expanding the uniform irrigation area and improving flexibility and applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an elevation view of a typical assembled impingement sprinkler.

FIG. 2 shows a schematic view of an irrigation range of typical impingement sprinkler.

FIG. 3 shows an elevation view of a preferred embodiment of the assembled present invention.

FIG. 4 shows a schematic view of the spray nozzle outflow of the preferred embodiment of the present invention.

FIG. 5 shows a partial sectional view of the preferred embodiment of the present invention.

FIG. 6 shows an elevation view of an adjustable spray nozzle of the present invention.

FIG. 7 shows an elevation view of an application of the present invention, having the adjustable spray hole of the adjustable spray nozzle set into tubular shapes.

FIG. 8 shows a schematic view of the irrigation area of the adjustable spray nozzle of the present invention.

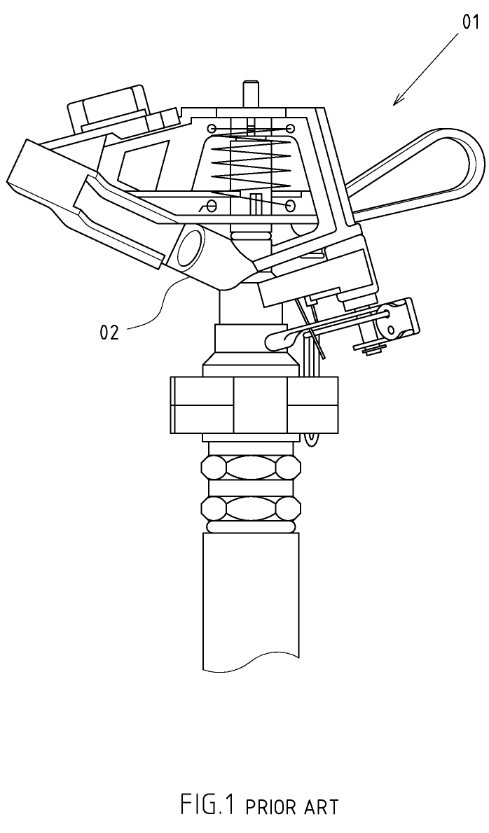

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

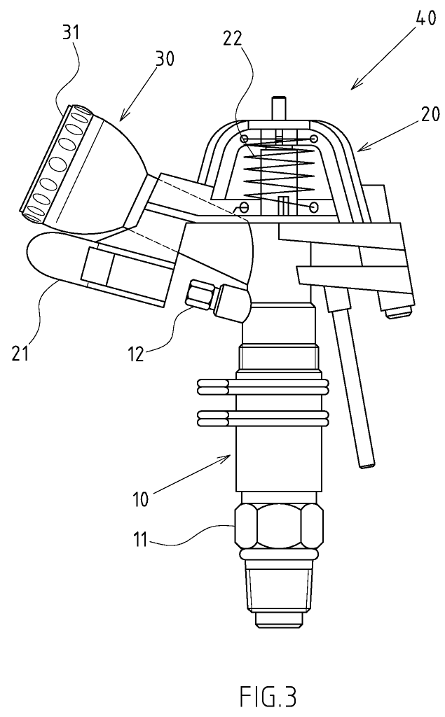

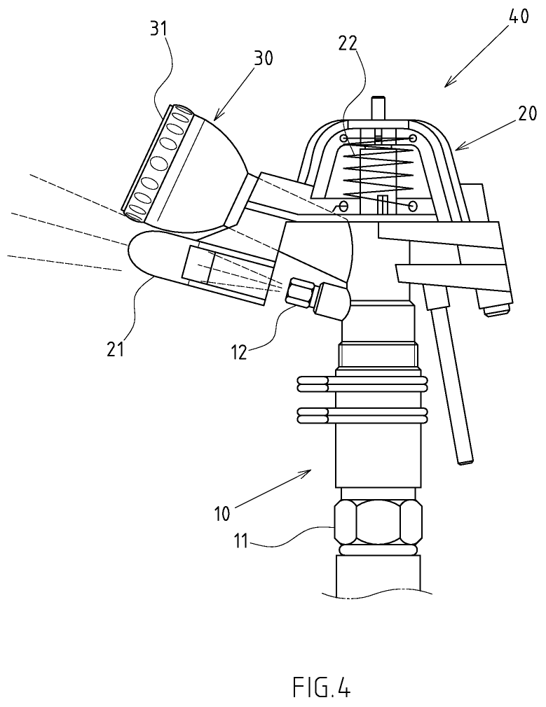

FIGS. 3-5 depict preferred embodiments of an impingement sprinkler of the present invention with variable outflow. The embodiments are provided only for explanatory purposes with respect to the patent claims.

The impingement sprinkler 40 comprises a main body 10, containing a moving inlet connector 11 bolted at the bottom. A spray nozzle 12 protrudes forwards from the top of the main body 10.

An impingement deflector ledge 20 is flexibly assembled onto preset location of the main body 10. A hydraulic pushing portion 21 and a torsional spring 22 are arranged laterally onto the impingement deflector ledge 20. The hydraulic pushing portion 21 is positioned correspondingly at intervals in front of the spray nozzle 12 of the main body 10.

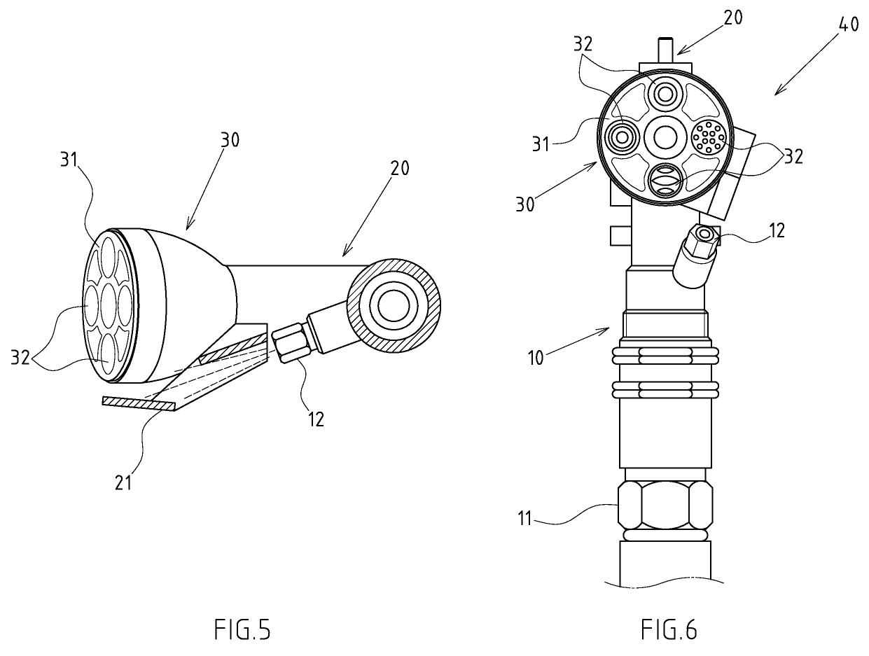

An adjustable spray nozzle 30 can be rotated manually to adjust the water outflow mode. The spray nozzle 30 is arranged at intervals with the spray nozzle 12 of the main body 10. At the spray end 31 of the adjustable spray nozzle 30, there are a plurality of adjustable spray holes 32 arranged circularly at intervals, and each outflow differs from each hole (referring also to FIG. 6) in tune with diversified customer demands.

Of which, the adjustable spray nozzle 30 can be assembled at intervals over the spray nozzle 12 of the main body 10.

The setting angle of the adjustable spray nozzle 30 is equal to, smaller or bigger than that of the spray nozzle 12 of the main body 10. When the setting angle of the adjustable spray nozzle 30 is bigger than the spray nozzle 12 of the main body 10, water spraying with a longer spraying distance will be realized. Otherwise, when the setting angle of the adjustable spray nozzle 30 is smaller than that of the spray nozzle 12 of the main body 10, water spraying with a shorter spraying distance will be realized. Besides, the influential factors to affect the spraying distance of the adjustable spray nozzle 30 include the type of water sprays generated from each particular adjustable spray hole 32 with varying outflow modes, for example, the spraying distance of a columnar spray is longer than that of misty one.

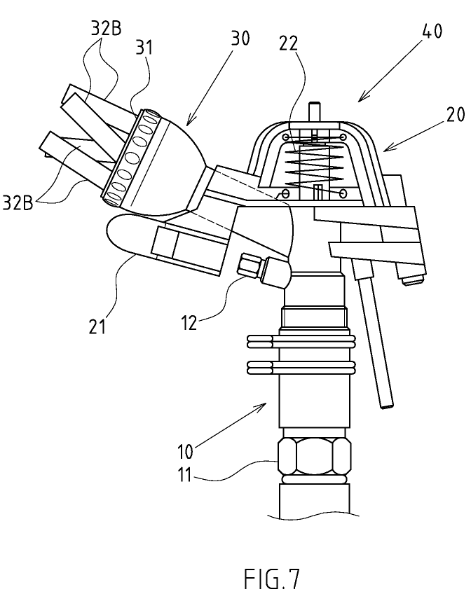

Referring to FIG. 7, the adjustable spray hole 32B of the adjustable spray nozzle 30 can also have various tubular shapes with different angles of elevation, making it possible to realize the intended spraying distance.

Based on above-specified structures, the present invention is operated as follows:

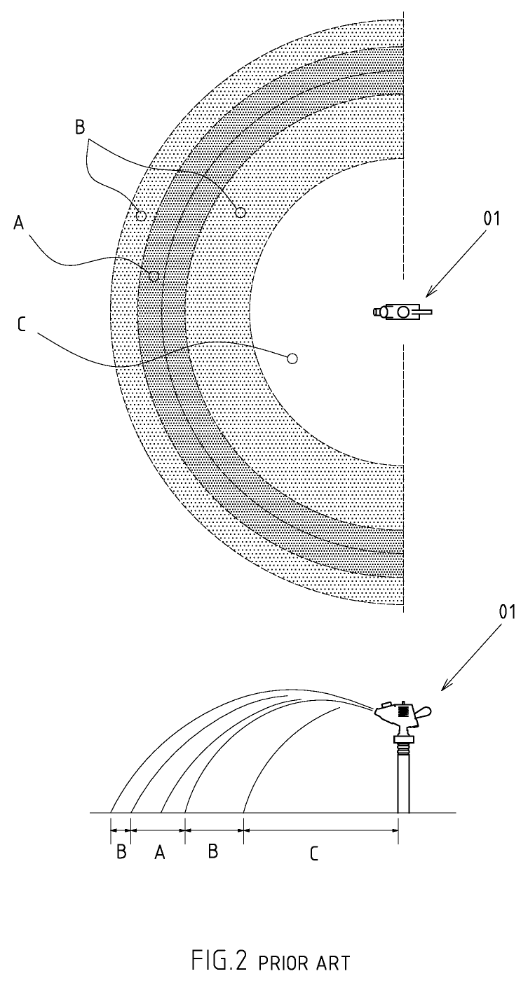

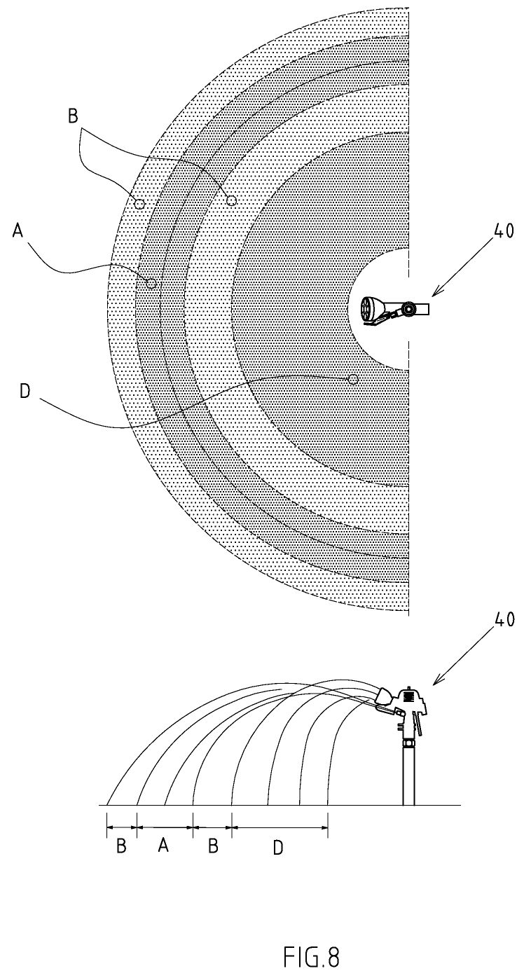

Referring to FIG. 8, there is a schematic view showing the irrigation area of the spray nozzle 12 of the main body 10 of the impingement sprinkler 40 with variable outflow. When the waterflow is fed into the main body 10 by a moving inlet connector 11 below the main body 10, then the waterflow is sprayed via the spray nozzle 12. A parabolic spraying distance will be set. With the arrangement of the impingement deflector ledge 20, the waterflow can be sprayed and also moved circularly. The adjustable spray nozzle 30 spraying of water with longer or shorter outflow distances, thereby changing the spraying angle to form different parabolic spraying distances. Thus, the irrigation area (shown in FIG. D) can be increased. Moreover, the adjustable spray nozzle 30 enables more uniform irrigation (in collaboration with the operating condition of the typical structure in FIG. 2). It is thus clear that, with the arrangement of adjustable spray nozzle 30, the water spraying can be set to expand the spraying and irrigation range as much as possible.

1. An impingement sprinkler with variable outflow, the sprinkler comprising:
a main body, having a top and a bottom and containing a moving inlet connector bolted on said bottom;
a spray nozzle protruding forwards from said top of said main body;
an impingement deflector ledge, being flexibly assembled onto a preset location of a main body, said impingement deflector ledge having a hydraulic pushing portion and a torsional spring arranged laterally thereon, said hydraulic pushing portion being positioned correspondingly at intervals in front of said spray nozzle of the main body; and
an adjustable spray nozzle, being positioned at said top of said main body, rotated manually to adjust a water outflow mode, and arranged at intervals with said spray nozzle of said main body, said adjustable spray nozzle having a spray end with a plurality of adjustable spray holes arranged circularly at interval, each spray hole having a different outflow.

2. The impingement sprinkler defined in claim 1, wherein said adjustable spray nozzle is assembled at intervals over said spray nozzle of said main body.

3. The impingement sprinkler defined in claim 1, wherein said adjustable spray nozzle having a setting angle, said spray nozzle of said main body having a setting angle.

4. The impingement sprinkler defined in claim 1, wherein said adjustable spray holes of said adjustable spray nozzle having various tubular shapes with different angles of elevation.
